(19) United States
(12) Patent Application Publication
(10) Pub. No.: US 2024/0145728 A1
(43) Pub. Date: May 2, 2024

(54) ALL-SOLID-STATE BATTERY WITH MINIMAL CHANGE IN VOLUME

(71) Applicants: Hyundai Motor Company, Seoul (KR); Kia Corporation, Seoul (KR)

(72) Inventors: Hee Soo Kang, Seoul (KR); Hong Suk Choi, Hwaseong (KR); Seon Hwa Kim, Cheongju (KR); Jae Min Lim, Suwon, Gyeonggi-do (KR); Sang Wan Kim, Anyang (KR)

(21) Appl. No.: 18/132,811

(22) Filed: Apr. 10, 2023

(30) Foreign Application Priority Data
Nov. 1, 2022 (KR) 10-2022-0143336

(51) Int. Cl. H01M 4/66; H01M 4/134; H01M 4/38

(52) U.S. Cl. CPC H01M 4/663; H01M 4/134; H01M 4/38; H01M 4/382

(57) ABSTRACT

Disclosed is an all-solid-state battery capable of suppressing volume expansion during charging and discharging.

### CROSS-REFERENCE TO RELATED APPLICATION

This application claims, under 35 U.S.C. § 119(a), the benefit of priority from Korean Patent Application No. 10-2022-0143336, filed on Nov. 1, 2022, the entire contents of which are incorporated herein by reference.

### TECHNICAL FIELD

The present disclosure relates to an all-solid-state battery capable of suppressing volume expansion during charging and discharging.

### BACKGROUND

An all-solid-state battery includes a cathode composite layer disposed on a cathode current collector, an anode composite layer disposed on an anode current collector, and a solid electrolyte layer interposed between the cathode composite layer and the anode composite layer.

The anode composite layer includes an anode active material such as graphite, silicon, etc. and a solid electrolyte. The solid electrolyte conducts lithium ions in the anode composite layer. However, since the solid electrolyte has a greater specific gravity than a liquid electrolyte, the energy density of the all-solid-state battery is lower than that of a lithium ion battery.

In order to overcome the above problems and increase the energy density of the all-solid-state battery, research into application of lithium metal as an anode has been conducted. However, there are many problems to overcome for commercialization, including not only research technology problems such as interfacial bonding, lithium dendrite growth, and the like, but also industrial technology problems such as price, large area, and the like.

Recently, research into a storage-type anodeless all-solid-state battery in which the anode is eliminated and lithium ions are directly deposited into lithium metal on the anode current collector has been reported.

### SUMMARY

In preferred aspects, the disclosure provides an all-solid-state battery capable of uniformly electrodepositing lithium.

Also provided is an all-solid-state battery in which volume change is minimized during charging and discharging.

The objects of the present disclosure are not limited to the foregoing. The objects of the present disclosure will be able to be clearly understood through the following description and to be realized by the means described in the claims and combinations thereof.

A term “all-solid-state battery” as used herein refers to a rechargeable secondary battery that includes an electrolyte in a solid state. In certain embodiments, the all-solid state battery may be an anodeless all-solid-state battery.

A term “anode-free all-solid-state battery,” “anodeless all-solid-state battery,” “anode-free battery,” or “anodeless battery” as used herein refers to an all-solid-state battery including a bare current collector at its anode side, which is in contrast to a battery that uses lithium metal as an anode. The anodeless all-solid-state battery may include a coating layer on the bare current collector containing materials that induce conduction of lithium ions to a surface of the bare current collector.

In an aspect, provided is an all-solid-state battery including an anode current collector, a buffer layer disposed on the anode current collector, an intermediate layer disposed on the buffer layer and including a carbon material and a metal capable of alloying with lithium, a solid electrolyte layer disposed on the intermediate layer, a cathode active material layer disposed on the solid electrolyte layer, and a cathode current collector disposed on the cathode active material layer.

The buffer layer may be porous and have elasticity.

The buffer layer may include an electrically conductive material.

The term “electrically conductive material” as used herein refers to a material that allows flow of electric current (e.g., electrons) or transports an electric charge (e.g., electrons) in one or more directions. Preferably, in the electrically conductive material may produce free electrons, positively charges holes, or positive or negative ions (e.g., proton, cations or anions) such that a directional electric current can be continued in or through the material.

The all-solid-state battery may further include a deposited layer disposed between the buffer layer and the intermediate layer. When the all-solid-state battery is charged, deposited layer may include lithium.

The buffer layer may satisfy Relation 1 below.

T_{b}>T_{d} [Relation 1]

Here, T_{b} may be the thickness of the buffer layer, and T_{d} may be the thickness of the deposited layer when state of charge (SOC) is 100.

When the capacity of the all-solid-state battery is less than about 1 mAh/cm², the thickness of the buffer layer may be about 4 μm to 10 μm.

When the capacity of the all-solid-state battery is about or greater than about 1 mAh/cm² but less than about 3 mAh/cm², the thickness of the buffer layer may be about 12 μm to 30 μm.

When the capacity of the all-solid-state battery is about or greater than about 3 mAh/cm² but less than about 5 mAh/cm², the thickness of the buffer layer may be about 20 μm to 50 μm.

When the capacity of the all-solid-state battery is about or greater than about 5 mAh/cm² but less than about 10 mAh/cm², the thickness of the buffer layer may be about 50 μm to 100 μm.

The buffer layer may have a porosity of about 50% or greater.

The buffer layer may have a tensile strength of about 50 GPa or less.

The buffer layer may have a Young's modulus of about 1 TPa or less.

The electrically conductive material may include a fibrous carbon material.

The buffer layer may include pores formed by a network in which the fibrous carbon material is interconnected in three dimensions.

The fibrous carbon material may include carbon nanotubes, carbon nanofibers, vapor grown carbon fibers, or combinations thereof.

The metal capable of alloying with lithium may include one or more selected from the group consisting of gold (Au), platinum (Pt), palladium (Pd), silicon (Si), silver (Ag), aluminum (Al), bismuth (Bi), tin (Sn), zinc (Zn), and magnesium (Mg).

The all-solid-state battery may have a volume change of about 1% or less between state of charge (SOC) 100 and state of charge (SOC) 0.

Also provided is a vehicle including the all-solid-state battery as described herein.

Other aspects of the invention are disclosed infra.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows an exemplary all-solid-state battery according to an exemplary embodiment of the present disclosure;

FIG. 2 shows an exemplary all-solid-state battery according to an exemplary embodiment of the present disclosure that is charged;

FIG. 3 shows results of analysis of the buffer layer of Example 2 using a scanning electron microscope (SEM);

FIG. 4 shows a reference diagram for explaining a process of measuring a change in thickness depending on charging and discharging of an all-solid-state battery;

FIG. 5 shows results of observation of the surface of the anode current collector after charging and discharging the all-solid-state battery according to Comparative Example several cycles;

FIG. 6A shows results of observation of the surface of the cathode current collector after charging and discharging the all-solid-state battery according to Example 2 several cycles;

FIG. 6B shows results of observation of the surface of the anode current collector after charging and discharging the all-solid-state battery according to Example 2 several cycles;

FIG. 7 shows results of measurement of charge capacity of all-solid-state batteries according to Examples 1 and 2 and Comparative Example;

FIG. 8 shows results of measurement of discharge capacity of the all-solid-state batteries according to Examples 1 and 2 and Comparative Example;

FIG. 9 shows a charge/discharge curve of the all-solid-state batteries according to Examples 1 and 2 and Comparative Example;

FIG. 10 shows results of measurement of capacity retention of the all-solid-state batteries according to Examples 1 and 2 and Comparative Example; and

FIG. 11 shows results of measurement of coulombic efficiency of the all-solid-state batteries according to Examples 1 and 2 and Comparative Example.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present disclosure, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

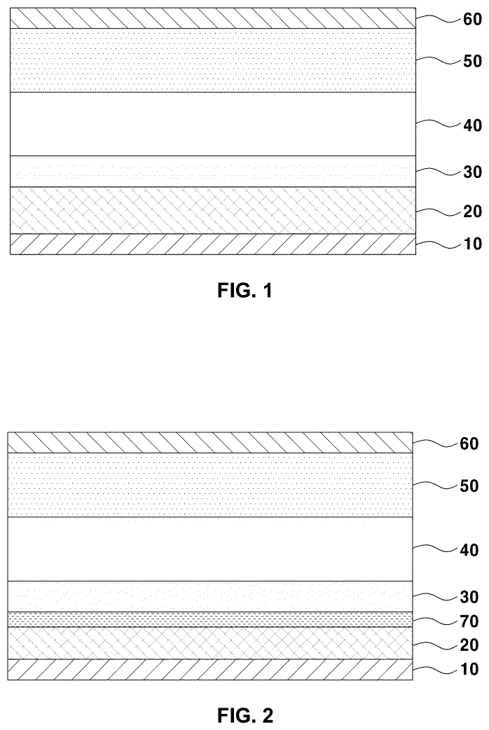

FIG. 1 shows an exemplary all-solid-state battery according to an exemplary embodiment of the present disclosure. The all-solid-state battery includes an anode current collector 10, an intermediate layer 30 disposed on the anode current collector 10, a solid electrolyte layer 40 disposed on the intermediate layer 30, a cathode active material layer 50 disposed on the solid electrolyte layer 40, and a cathode current collector 60 disposed on the cathode active material layer 50.

The anode current collector 10 may be an electrically conductive plate-like substrate. Particularly, the anode current collector 10 may be provided in the form of a sheet, a thin film, or a foil.

The anode current collector 10 may include a material that does not react with lithium. Particularly, the anode current collector 10 may include Ni, Cu, stainless steel (SUS), or combinations thereof.

The thickness of the anode current collector 10 is not particularly limited, and may be, for example, about 1 μm to 500 μm.

The intermediate layer 30 may include a carbon material and a metal capable of alloying with lithium.

The carbon material may include amorphous carbon. The amorphous carbon is not particularly limited, but may include, for example, furnace black, acetylene black, Ketjen black, or the like.

The metal may include one or more selected from the group consisting of gold (Au), platinum (Pt), palladium (Pd), silicon (Si), silver (Ag), aluminum (Al), bismuth (Bi), tin (Sn), and zinc (Zn).

The amount of each component of the intermediate layer 30 is not particularly limited and may be appropriately adjusted for a desired effect. For example, the intermediate layer 30 may include about 50% by weight to 99% by weight of the carbon material and about 1% by weight to 50% by weight of the metal, based on the total weight of the intermediate layer.

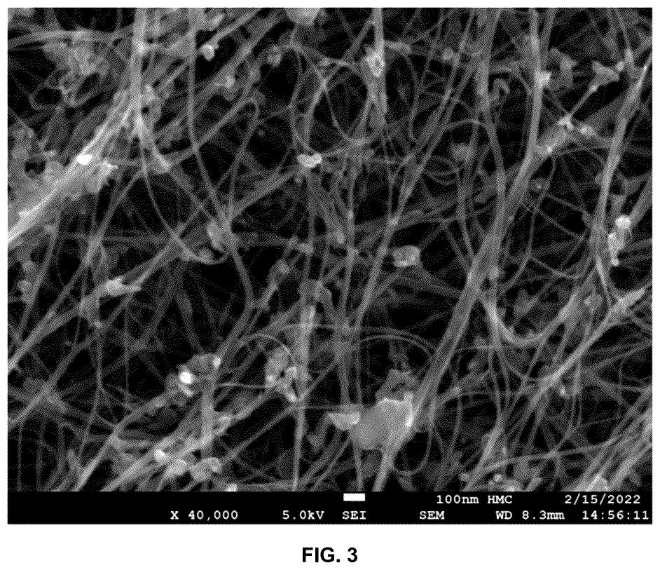

FIG. 2 shows the all-solid-state battery that is charged. The all-solid-state battery may further include a deposited layer 70 disposed between the anode current collector 10 and the intermediate layer 30, which may contain lithium when the all-solid-state battery is charged. At the initial stage of charging of the all-solid-state battery, lithium ions that are deintercalated from the cathode active material layer 50 move to the intermediate layer 30 through the solid electrolyte layer 40. The lithium ions react with the metal of the intermediate layer 30 to form a lithium alloy between the anode current collector 10 and the intermediate layer 30 or within the intermediate layer 30. When charging is continued, lithium is uniformly deposited around the lithium alloy to form the deposited layer 70.

A typical anodeless all-solid-state battery expands and contracts by the volume of the deposited layer 70 during repeated charging and discharging. Due to the repeated volume change as described above, interfacial contact between the layers becomes poor, the deposited layer 70 is non-uniformly formed, and pressure imbalance in the all-solid-state battery occurs, which adversely affects cell performance and lifespan.

In order to solve the problems described above, a thick pad may be attached to the outside of the all-solid-state battery. However, when the all-solid-state battery is a stack including a plurality of single cells, an increase in the thickness due to the presence of the pad is not a level that may be ignored, making it difficult to apply the pad.

The present disclosure is characterized in that a change in the volume of the all-solid-state battery is minimized by interposing a buffer layer 20 which is porous and has elasticity between the anode current collector 10 and the intermediate layer 30.

The buffer layer 20 is porous and has elasticity, thus offsetting a change in the volume due to the deposited layer 70 formed between the buffer layer 20 and the intermediate layer 30.

The volume of the deposited layer 70 may vary depending on the capacity of the all-solid-state battery. Particularly, the volume of the deposited layer 70 may increase with an increase in the capacity of the cathode active material layer 50. Therefore, the thickness of the buffer layer may be preferably adjusted so as to satisfy Relation 1 below.

T_{b}>T_{d} [Relation 1]

Here, T_{b} may be the thickness of the buffer layer 20, and T_{d} may be the thickness of the deposited layer 70 when state of charge (SOC) is 100.

As such, 100 of state of charge (SOC) may indicate a state in which the all-solid-state battery is fully charged, and 0 of state of charge (SOC) may indicate a state in which the all-solid-state battery is fully discharged.

The thickness of the buffer layer 20 in Relation 1 may indicate a thickness when state of charge (SOC) is 0. Particularly, the thickness of the buffer layer 20 in Relation 1 may represent a thickness in a non-pressed state in the absence of the deposited layer 70. Therefore, when state of charge (SOC) is 100, it can be said that the buffer layer 20 satisfies Relation 1 even though the buffer layer 20 is thinner than the deposited layer 70. However, the thickness of the buffer layer 20 in Relation 1 is not limited thereto, and may also represent a thickness when state of charge (SOC) is 100. Accordingly, the buffer layer 20 may be thicker than the deposited layer 70 regardless of the state of charge of the all-solid-state battery.

In particular, when the capacity of the all-solid-state battery is less than about 1 mAh/cm², the thickness of the buffer layer 20 may be about 4 μm to 10 μm. When the capacity of the all-solid-state battery is about or greater than about 1 mAh/cm² but less than about 3 mAh/cm², the thickness of the buffer layer 20 may be about 12 μm to 30 μm. When the capacity of the all-solid-state battery is about or greater than about 3 mAh/cm² but less than about 5 mAh/cm², the thickness of the buffer layer 20 may be 20 μm to 50 μm. When the capacity of the all-solid-state battery is about or greater than about 5 mAh/cm² but less than about 10 mAh/cm², the thickness of the buffer layer 20 may be about 50 μm to 100 μm. A change in the volume of the all-solid-state battery may be minimized by adjusting the thickness of the buffer layer 20 depending on the capacity of the all-solid-state battery as described above.

The buffer layer 20 may have a porosity of about 50% or greater. The upper limit of the porosity is not particularly limited and may be about 85% or less, 90% or less, 95% or less, or 99% or less. When the porosity of the buffer layer 20 is about 50% or greater, volume expansion caused by formation of the deposited layer 70 may be offset.

When the deposited layer 70 disappears due to discharge of the all-solid-state battery, the buffer layer 20 may offset the volume reduction of the all-solid-state battery. Briefly, the buffer layer 20 may have a certain level of elasticity. The buffer layer 20 may have a Young's modulus of about 1 TPa or less. The lower limit of the Young's modulus is not particularly limited, and may be about 10 GPa or greater, about 20 GPa or greater, or about 30 GPa or greater.

The buffer layer 20 may have a certain level of strength because it is necessary to maintain a layered structure between the anode current collector 10 and the intermediate layer 30. The buffer layer 20 may have a tensile strength of about 50 GPa or less. The lower limit of the tensile strength is not particularly limited, and may be about 10 GPa or greater.

The buffer layer 20 may conduct electrons between the anode current collector 10 and the intermediate layer 30. The electronic conductivity of the buffer layer 20 is not particularly limited, and may be, for example, about 1.0×10⁸ S/m or less.

The buffer layer 20 may include an electrically conductive material. The electrically conductive material may include a fibrous carbon material. The buffer layer 20 may include pores formed by a network in which the fibrous carbon material is interconnected in three dimensions.

The fibrous carbon material may include carbon nanotubes, carbon nanofibers, vapor grown carbon fibers, or combinations thereof.

The buffer layer 20 may include a carbon nanotube sheet.

The solid electrolyte layer 40 may be interposed between the cathode active material layer 50 and the intermediate layer 30 and may include a solid electrolyte having lithium-ion conductivity.

Examples of the solid electrolyte may include an oxide-based solid electrolyte, a sulfide-based solid electrolyte, and the like. Here, the use of a sulfide-based solid electrolyte having high lithium ion conductivity is preferable. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—SiS₂, Li₂S—SiS₂—LiBr, Li₂S—SiS₂—LiCl, Li₂S—B₂S₃, Li₂S—P₂S₅—ZmSo (in which m and n are positive numbers and Z is any one of Ge, Zn, and Ga), Li₂S—GeS₂, Li₂S—SiS₂—Li₃PO₄, Li₂S—SiS₂—LiₓMO_{y} (in which x and y are positive numbers and M is any one of P, Si, Ge, B, Al, Ga, and In), Li₁₀GeP₂S₁₂, and the like.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), and the like.

The cathode active material layer 50 may include a cathode active material, a solid electrolyte, a conductive material, and a binder.

The cathode active material may include an oxide-based active material.

Examples of the oxide-based active material may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one of Al, Mg, Co, Fe, Ni and Zn, 0<x+y<₂), lithium titanate such as Li₄Ti₅O₁₂, and the like.

The solid electrolyte may include an oxide-based solid electrolyte or a sulfide-based solid electrolyte. It is preferable to use a sulfide-based solid electrolyte having high lithium ion conductivity. The sulfide-based solid electrolyte is not particularly limited, but examples thereof may include Li₂S—P₂S₅, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiBr, Li₂S—SiS₂—LiCl, Li₂S—B₂S₃, Li₂S—P₂S₅—ZₘSₙ (in which m and n are positive numbers and Z is any one of Ge, Zn, and Ga), Li₂S—GeS₂, Li₂S—SiS₂—Li₃PO₄, Li₂S—SiS₂—LiₓMO_{y} (in which x and y are positive numbers and M is any one of P, Si, Ge, B, Al, Ga, and In), Li₁₀GeP₂S₁₂, and the like.

Examples of the conductive material may include carbon black, conductive graphite, ethylene black, graphene, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode current collector 60 may include an electrically conductive plate-like substrate. The cathode current collector 60 may include an aluminum foil.

### EXAMPLE

A better understanding of the present disclosure may be obtained through the following examples. However, these examples are merely set forth to illustrate the present disclosure and are not to be construed as limiting the scope of the present disclosure.

### Example 1

A buffer layer was formed by stacking a carbon nanotube sheet having a porosity of about 85% and a thickness of 30 μm on an anode current collector. An intermediate layer including amorphous carbon and silver (Ag) was formed on the buffer layer.

A solid electrolyte layer including a sulfide-based solid electrolyte and a binder was prepared.

A cathode active material layer was formed by applying a slurry including a cathode active material, a sulfide-based solid electrolyte, a binder, and a conductive material onto an aluminum foil serving as a cathode current collector and then drying the same.

An all-solid-state battery was manufactured by forming a layered structure in which the intermediate layer and the cathode active material layer were placed on respective sides of the solid electrolyte layer.

### Example 2

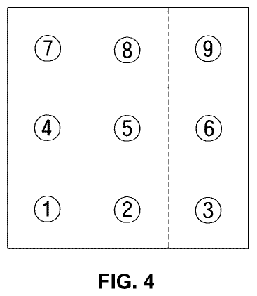

An all-solid-state battery was manufactured in the same manner as in Example 1, with the exception that a carbon nanotube sheet having a porosity of 50% was used as the buffer layer. FIG. 3 shows results of analysis of the buffer layer using a scanning electron microscope (SEM). It can be seen that a net structure containing pores therein was formed by entangling carbon nanotubes.

### Comparative Example

An all-solid-state battery was manufactured in the same manner as in Example 1, with the exception that a buffer layer was not formed.

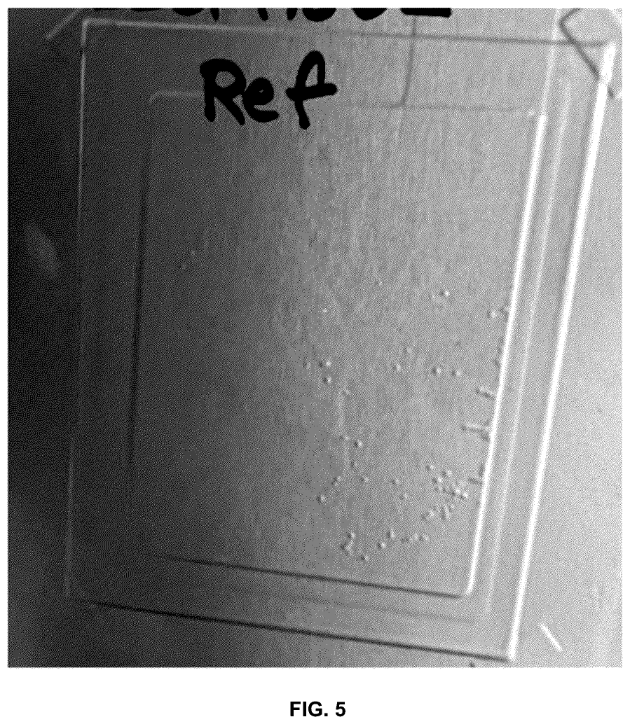

The extent of volume expansion of the all-solid-state battery was evaluated by measuring a change in the thickness during charging and discharging of the all-solid-state batteries according to Examples 1 and 2 and Comparative Example. FIG. 4 shows a plan view of the all-solid-state battery. As shown in FIG. 4, the all-solid-state battery was divided into nine equal portions, and the thickness of each portion was measured at the initial stage, state of charge (SOC) 100, and state of charge (SOC) 0.

TABLE 1

| | Comparative Example [μm] | | | Example 1 [μm] | | | Example 2 [μm] | | |
|---|---|---|---|---|---|---|---|---|---|
| Classification | Initial | SOC 100 | SOC 0 | Initial | SOC 100 | SOC 0 | Initial | SOC 100 | SOC 0 |
| 1 | 517 | 531 | 525 | 548 | 549 | 547 | 533 | 533 | 532 |
| 2 | 516 | 524 | 518 | 543 | 546 | 544 | 529 | 531 | 530 |
| 3 | 517 | 526 | 519 | 544 | 547 | 544 | 533 | 533 | 532 |
| 4 | 519 | 530 | 523 | 548 | 549 | 547 | 532 | 532 | 532 |
| 5 | 514 | 526 | 519 | 544 | 545 | 545 | 533 | 533 | 533 |
| 6 | 518 | 531 | 524 | 548 | 549 | 548 | 529 | 531 | 530 |
| 7 | 514 | 529 | 522 | 547 | 547 | 547 | 532 | 533 | 532 |
| 8 | 513 | 528 | 521 | 546 | 546 | 546 | 531 | 532 | 532 |
| 9 | 520 | 529 | 522 | 547 | 548 | 547 | 532 | 532 | 532 |
| Average | 516 | 528 | 521 | 546 | 547 | 546 | 532 | 533 | 532 |

In Comparative Example without a buffer layer, the thickness was increased by about 12 μm during charging and was decreased by about 7 μm during discharging, whereas in Examples 1 and 2, the thickness change during charging and discharging was very small to the level of about 1 μm or less. Therefore, the all-solid-state battery according to the present disclosure may have a volume change of 1% or less, 0.5% or less, or 0.2% or less between SOC 100 and SOC 0.

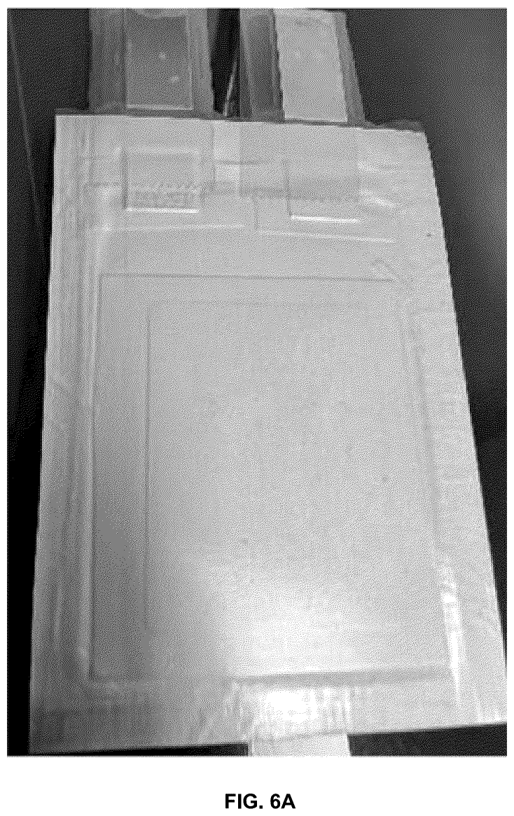

FIG. 5 shows results of observation of the surface of the anode current collector after charging and discharging the all-solid-state battery according to Comparative Example several cycles. It can be confirmed that fine cracks were generated on the surface of the anode current collector due to the formation of the deposited layer.

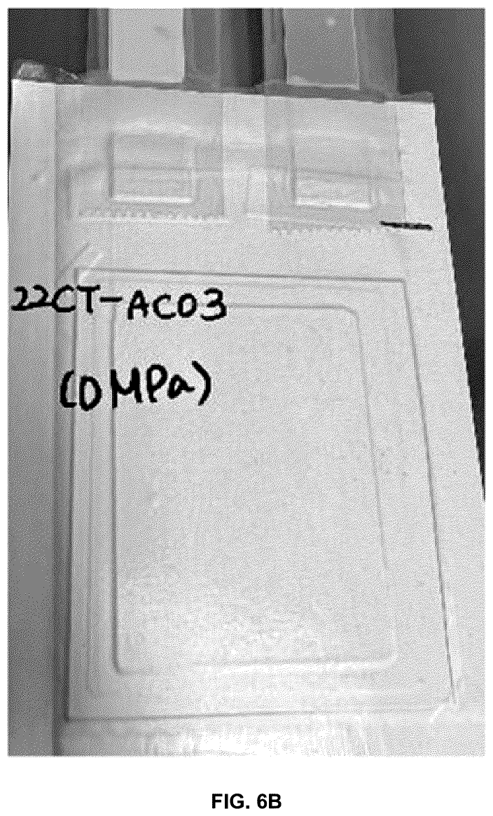

FIG. 6A shows results of observation of the surface of the cathode current collector after charging and discharging the all-solid-state battery according to Example 2 several cycles. FIG. 6B shows results of observation of the surface of the anode current collector after charging and discharging the all-solid-state battery according to Example 2 several cycles. It can be seen that both surfaces were smooth without any cracks.

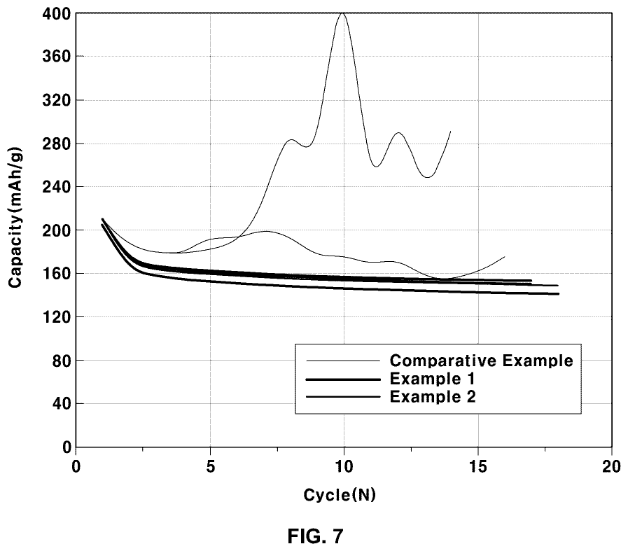

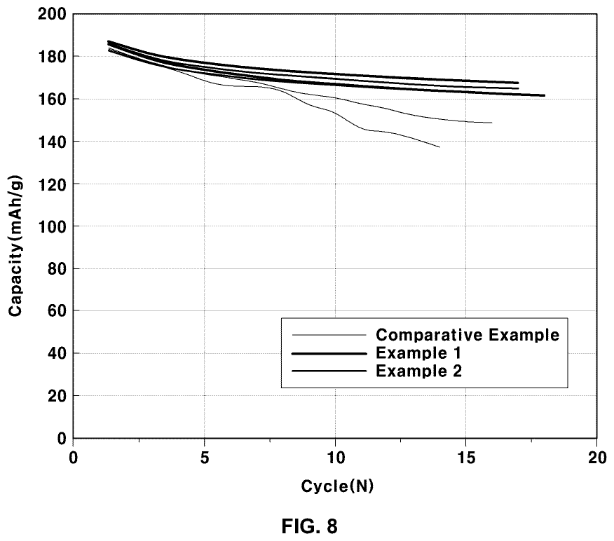

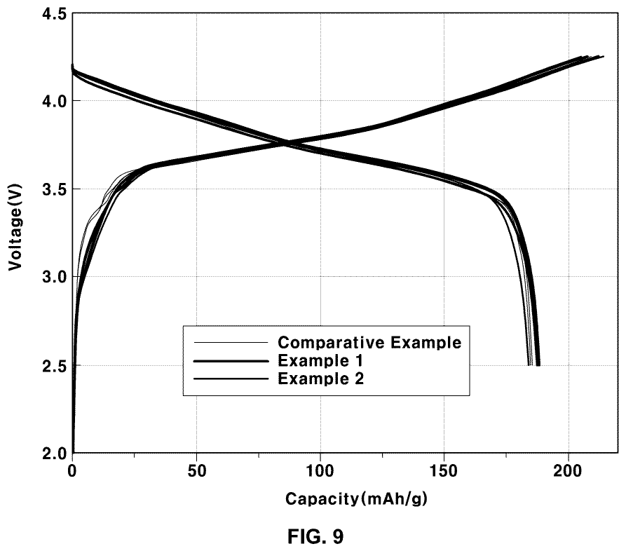

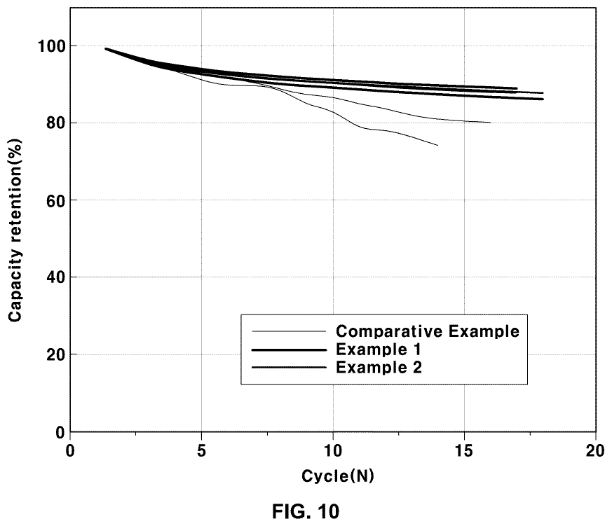

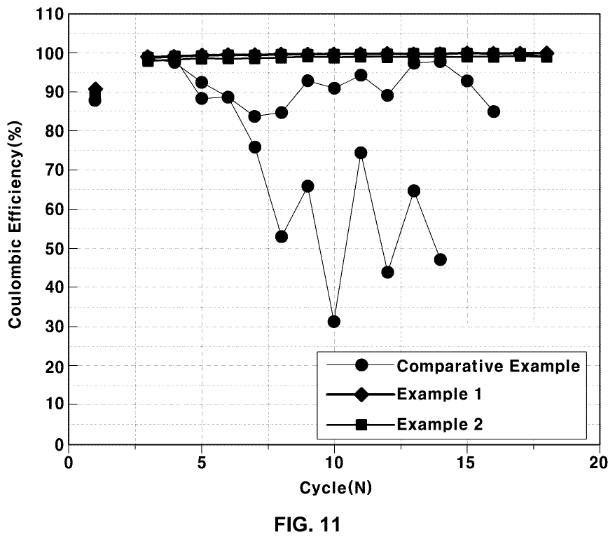

Cell performance and lifespan of the all-solid-state batteries according to Examples 1 and 2 and Comparative Example were measured. FIG. 7 shows results of measurement of charge capacity of the all-solid-state batteries according to Examples 1 and 2 and Comparative Example. FIG. 8 shows results of measurement of discharge capacity of the all-solid-state batteries according to Examples 1 and 2 and Comparative Example. FIG. 9 shows a charge/discharge curve of the all-solid-state batteries according to Examples 1 and 2 and Comparative Example. FIG. 10 shows results of measurement of capacity retention of the all-solid-state batteries according to Examples 1 and 2 and Comparative Example. FIG. 11 shows results of measurement of coulombic efficiency of the all-solid-state batteries according to Examples 1 and 2 and Comparative Example. Specific measured values are shown in Table 2 below.

TABLE 2

| | Comparative | Example | Example |
|---|---|---|---|
| Classification | Example | 1 | 2 |
| Charge capacity [mAh/g] | 209.8 | 207 | 209.5 |
| Discharge capacity [mAh/g] | 185.1 | 187.8 | 185.8 |
| Efficiency [%] | 88.3 | 90.7 | 88.7 |
| Average discharge voltage [V] | 3.74 | 3.74 | 3.74 |
| DC-IR [Ω] | 1.65 | 1.61 | 1.60 |
| Capacity retention after 10 cycles | 85.2 | 90.1 | 90.4 |
| of charging and discharging [%] | | | |
| Coulombic efficiency after 10 | 31.4/90.9 | 99.6 | 99.1 |
| cycles of charging and discharg- | | | |
| ing [%] | | | |

Examples 1 and 2 exhibited high capacity and stable charging and discharging compared to Comparative Example.

As is apparent from the above description, according to various exemplary embodiment of the present disclosure, an all-solid-state battery capable of uniformly electrodepositing lithium can be obtained. Further, according to various exemplary embodiment of the present disclosure, an all-solid-state battery with minimized volume change during charging and discharging can be obtained.

According to various exemplary embodiment of the present disclosure, an all-solid-state battery with improved cell performance and lifespan can be obtained.

The effects of the present disclosure are not limited to the above-mentioned effects. It should be understood that the effects of the present disclosure include all effects that can be inferred from the description of the present disclosure.

As described hereinbefore, the present disclosure has been described in detail with reference to embodiments. However, the scope of the present disclosure is not limited to the aforementioned examples, and various modifications and improved modes of the present disclosure using the basic concept of the present disclosure defined in the accompanying claims are also incorporated in the scope of the present disclosure.

What is claimed is:

1. An all-solid-state battery, comprising:
an anode current collector;
a buffer layer disposed on the anode current collector, wherein the buffer layer is porous and has elasticity and the buffer layer comprises an electrically conductive material;
an intermediate layer disposed on the buffer layer and comprising a carbon material and a metal capable of alloying with lithium;
a solid electrolyte layer disposed on the intermediate layer;
a cathode active material layer disposed on the solid electrolyte layer; and
a cathode current collector disposed on the cathode active material layer.

2. The all-solid-state battery of claim 1, wherein the all-solid-state battery further comprises a deposited layer interposed between the buffer layer and the intermediate layer, and when the all-solid-state battery is charged, and the deposited layer comprises lithium.

3. The all-solid-state battery of claim 2, wherein the buffer layer satisfies Relation 1 below:
T_{b}>T_{d} [Relation 1]
wherein T_{b} is a thickness of the buffer layer, and T_{d} is a thickness of the deposited layer when state of charge (SOC) is 100.

4. The all-solid-state battery of claim 1, wherein, when a capacity of the all-solid-state battery is less than about 1 mAh/cm², a thickness of the buffer layer is about 4 μm to 10 μm.

5. The all-solid-state battery of claim 1, wherein, when a capacity of the all-solid-state battery is about or greater than about 1 mAh/cm² but less than about 3 mAh/cm², a thickness of the buffer layer is about 12 μm to 30 μm.

6. The all-solid-state battery of claim 1, wherein, when a capacity of the all-solid-state battery is about or greater than about 3 mAh/cm² but less than about 5 mAh/cm², a thickness of the buffer layer is about 20 μm to 50 μm.

7. The all-solid-state battery of claim 1, wherein, when a capacity of the all-solid-state battery is about or greater than about 5 mAh/cm² but less than about 10 mAh/cm², a thickness of the buffer layer is about 50 μm to 100 μm.

8. The all-solid-state battery of claim 1, wherein the buffer layer has a porosity of about 50% or greater.

9. The all-solid-state battery of claim 1, wherein the buffer layer has a tensile strength of about 50 GPa or less.

10. The all-solid-state battery of claim 1, wherein the buffer layer has a Young's modulus of about 1 TPa or less.

11. The all-solid-state battery of claim 1, wherein the electrically conductive material comprises a fibrous carbon material, and the buffer layer comprises pores formed by a network in which the fibrous carbon material is interconnected in three dimensions.

12. The all-solid-state battery of claim 11, wherein the fibrous carbon material comprises carbon nanotubes, carbon nanofibers, vapor grown carbon fibers or any combination thereof.

13. The all-solid-state battery of claim 1, wherein the metal capable of alloying with lithium comprises one or more selected from the group consisting of gold (Au), platinum (Pt), palladium (Pd), silicon (Si), silver (Ag), aluminum (Al), bismuth (Bi), tin (Sn), zinc (Zn), and magnesium (Mg).

14. The all-solid-state battery of claim 1, wherein the all-solid-state battery has a volume change of about 1% or less between state of charge (SOC) 100 and state of charge (SOC) 0.

15. A vehicle comprising an all-solid-state battery of claim 1.
